(19) United States
(12) Patent Application Publication
(10) Pub. No.: US 2007/0204837 A1
(43) Pub. Date: Sep. 6, 2007

(54) Fuel Injector With Multi-Part, Directly-Controlled Injection Valve Member

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/576,070

(22) PCT Filed: Sep. 6, 2004
(86) PCT No.: PCT/DE04/01995

§ 371 Date: Dec. 20, 2006

(30) Foreign Application Priority Data
Oct. 18, 2003 (DE) 103 48 925.8

(51) Int. Cl. F02M 51/00

(52) U.S. Cl. 123/472

(57) ABSTRACT

A fuel injector for a common rail injection system for injecting fuel into a combustion chamber of an internal combustion engine includes an injector body and a nozzle body with an injection valve member embodied in multiple parts received in the nozzle body. A hydraulic booster assembly connected downstream of a piezoelectric actuator. Control chambers are associated with the multi-part injection valve member for actuating it. The hydraulic booster assembly actuated by the piezoelectric actuator has booster chambers, which are each directly connected hydraulically with control chambers that actuate the needle parts of the injection valve member.

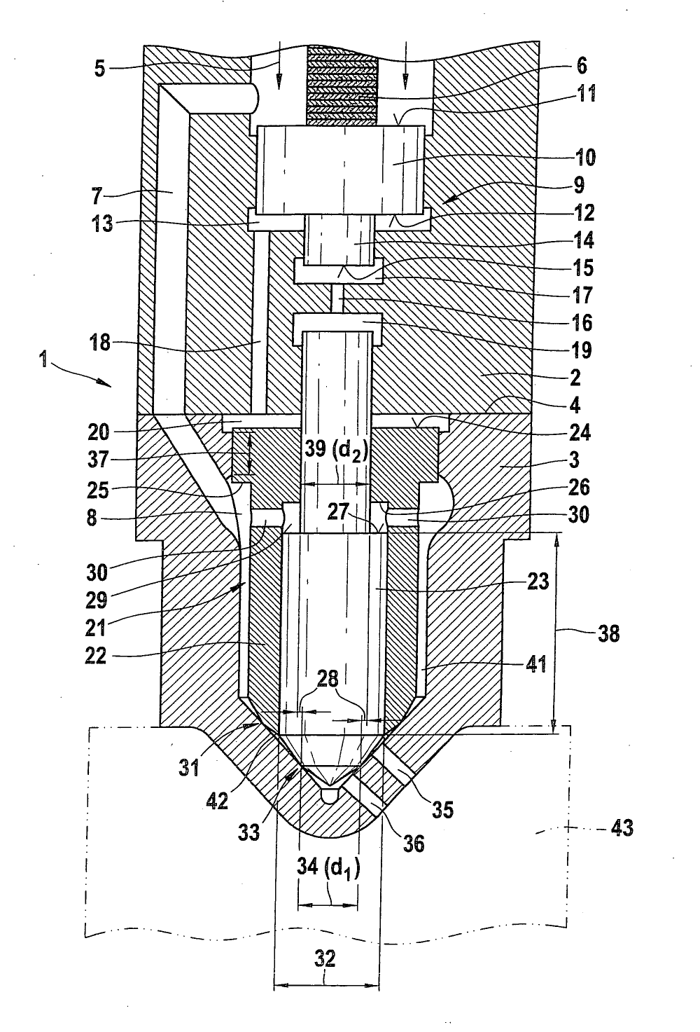

### BACKGROUND OF THE INVENTION

In self-ignition internal combustion engines, common rail injection systems are used for fuel injection; they enable adjusting the injection pressure independently of rpm and load. In common rail injection systems, the pressure generation and injection are spatially decoupled from one another. The injection pressure is generated by a separate high-pressure pump. It need not be driven synchronously with the injections. The pressure can be adjusted independently of the engine rpm and the injection quantity. Instead of pressure-controlled injection valves, in this fuel injection system, electrically actuated injectors are used; with their triggering time, that is, the instant and duration of triggering, the injection onset and the quantities injected into the combustion chambers of the engine are determined. In common rail injection systems, this makes for great freedom in terms of designing and shaping multiple or divided injection events.

### PRIOR ART

From German Patent Disclosure DE 190 55 271 A1, a pressure-/stroke-controlled injector with a hydraulic booster is known. In an injector housing, 2/2-way control valves are received, whose vertical motion is coupled together via a bridge. The 2/2-way control valves are located on the inlet and outlet sides and precede a hydraulic booster. The hydraulic booster subjects a pressure chamber, surrounding a nozzle needle, to fuel that is at high pressure. The two 2/2-way control valves are received diametrically opposed to one another in the housing of the fuel injector.

A disadvantage of the embodiment known from DE 190 55 271 A1 is the many individual parts needed to achieve pressure-/stroke-controlled injector triggering in accordance with this embodiment.

From German Patent DE 199 46 838 C1, a valve for controlling fluids is known. The valve includes a valve member, which is axially displaceable in a bore of a valve body. The valve member has a valve head, forming the valve closing member, which for opening and closing the valve cooperates with a seat provided on the valve body. A piezoelectric unit for actuating the valve member is provided, as is a tolerance-compensating element to compensate for elongation tolerances of the piezoelectric unit and/or of other valve components. The piezoelectric unit, in terms of its operative direction, is disposed essentially at a right angle to the axial direction of motion of the valve member and can be subjected to an electric current such that the piezoelectric unit exerts a tilting motion on a final control element that acts as a lever arm and is operatively connected to the valve member.

### SUMMARY OF THE INVENTION

The embodiment proposed according to the present invention is distinguished in that with a needle-like injection valve member embodied in multiple parts, different injection cross sections in the combustion chamber of a self-ignition internal combustion engine can be opened, and the multi-part injection valve member is in particular directly triggered. For direct triggering of the needle-like injection valve member embodied in multiple parts, a hydraulic booster assembly, which has two booster chambers, is provided between a piezoelectric actuator and the multi-part, needle-like injection valve member. Each of the two booster chambers acts on a control chamber for triggering an inner needle part and for triggering an outer needle part of the multi-part, needle-like injection valve member.

The inner and outer needle parts of the multi-part injection valve member have pressure steps, which enable chronologically staggered opening of the needle parts of the multi-part injection valve member both when pressure is exerted on a nozzle chamber in the nozzle body and when the control chambers are pressure-relieved. As a result, during a first phase of the injection of fuel into the combustion chamber of a self-ignition engine via a first injection opening cross section, and in the further course of the injection, upon the later opening of the inner needle part of the multi-part injection valve member, a further opening cross section is opened, so that toward the end of the injection event, more fuel reaches the combustion chamber than at the onset of the injection event. Accordingly, in partial-load engine operation, only one injection cross section is opened, while in full-load operation, both needle parts of the multi-part injection valve member are open, so that the maximum injection quantity can be injected into the combustion chamber of the engine.

Because of the design of pressure steps embodied on the outer needle part of the multi-part injection valve member, the hydraulic forces acting on the outer needle part can be adjusted such that even at the least pressures, the extremely small-quantity capability of the fuel injector is assured. Because two pressure steps are embodied on the outer needle part of the multi-part injection valve member, the latter opens very early, while conversely the inner needle part of the multi-part injection valve member opens later, since the pressure step embodied on it is designed to be quite small. Because of this design of the two pressure steps on the outer needle part and of the pressure step on the inner needle part, it can be attained that the two needle parts of the multi-part, needle-like injection valve member can be switched to different pressure levels from one another.

### DRAWING

The invention is described in further detail below in conjunction with the drawings.

The sole drawing FIGURE is a section through the fuel injector, provided according to the invention, with a multi-part, needle-like injection valve member and a hydraulic booster assembly, by way of whose booster chambers, control chambers associated with the inner and outer needle parts, respectively, of the multi-part injection valve member can be pressure-relieved or subjected to pressure.

### VARIANT EMBODIMENT

The fuel injector 1 shown in the drawing includes an injector body 2 and a nozzle body 3. The injector body 2 and the nozzle body 3, in the installed state, contact one another at a butt joint 4. The fuel flows to the injector body 2 via a common rail, not shown in the drawing, of a high-pressure common rail injection system via a fuel inlet 5. An actuator 6, with which a hydraulic booster assembly 9 is associated, is received in the region of the injector body 2. From the fuel inlet 5, a high-pressure supply line 7 in the injector body 2 branches off, by way of which the fuel at high pressure, flowing to the injector body 2, flows into a nozzle chamber 8. The nozzle chamber is located in the nozzle body 3 and surrounds an injection valve member 21, which is embodied in multiple parts and is received movably in the vertical direction in the nozzle body 3.

The hydraulic booster assembly 9 includes a booster piston 10. The booster piston 10 has a first end face 11, which is diametrically opposite the actuator 6. A second end face 12 of the booster piston 10 defines a first booster chamber 13 of the of the hydraulic booster assembly 9. Located on the booster piston 10 is a booster piston extension 14, which is embodied with a lesser diameter than the diameter of the booster piston 10. One face end 15 of the booster piston extension 14 protrudes into a second booster chamber 17. Extending from the second booster chamber 17 is a conduit 16, which discharges into a first control chamber 19. An overflow line 18 extends parallel to the conduit 16, and by way of it the first booster chamber 13 and a second control chamber 20 communicate hydraulically with one another.

The multi-part, needle-like injection valve member 21 has an outer needle part 22 and an inner needle part 23, the inner needle part being movable inside the outer needle part. The inner needle part 23 is acted upon by the first control chamber 19, which is in communication with the second booster chamber 17 of the hydraulic booster assembly, while the outer needle part 22 is actuated via the second control chamber 20, which is in communication with the first booster chamber 13 via the overflow line 18. The outer needle part 22 has an end face 24, toward the control chamber and defining the second control chamber 20, and a first pressure step 25 on its outside, as well as a further, second pressure step 26, which is embodied on the inside of the outer needle part 22. Between the outer needle part 22 and the inner needle part 23, a pressure chamber 29 is embodied, which is defined by an annular face 27 embodied on the inner needle part 23. The action on the inner pressure chamber 29 is exerted via pressure chamber inlets 30, which pierce the wall of the outer needle part 22. Through the pressure chamber inlets 30, an overflow of fuel, which flows at high pressure into the nozzle chamber 8, into the inner pressure chamber 29 between the outer needle part 22 and the inner needle part 23 is assured.

On the outer circumference of the end toward the combustion chamber of the outer needle part 22, a seat 31 is embodied, which has a first seat diameter 32. The seat edge embodied with the first seat diameter 32 cooperates with the wall of the nozzle body 3. A second seat 33, likewise cooperating with the wall of the nozzle body, is embodied on the inner needle part 23, which is guided in the outer needle part 22 of the multi-part injection valve member 21. The seat diameter of the seat 33 of the inner needle part 23 is embodied with a second seat diameter 34 (d₁), which is considerably smaller than the first seat diameter 32 of the outer needle part 22. In the closed state, shown in the drawing, of the multi-part injection valve member 21, first injection openings 35 are separated by the closed seat 31 of the outer needle part 22 from an annular gap 41, in which fuel at high pressure is present via the nozzle chamber 8. By means of the seat 33 of the inner needle part 23, also shown in its closed state in the drawing, second injection openings 36 are also closed off from the fuel at high pressure that is present in the annular gap 41. In the closed state, shown in the drawing, of the multi-part, needle-like injection valve member 21, a wedge-shaped annular chamber 42 forms between the seat 31 of the outer needle part 22 and the seat 33 of the inner needle part 23. The combustion chamber, into which when the multi-part injection valve member 21 is open fuel is injected either via the first injection openings 35 or via the opened first and second injection openings 35, 36, is identified by reference numeral 43.

The outer needle part 22 of the multi-part, needle-like injection valve member 21 is received in a guide length 37 in the nozzle body 3, while the inner needle part 23 is defined in a guide length 38, which extends into this body 3 between the pressure chamber inlets 30 of the outer needle part 23 and its seat 31. Although not shown in detail in the drawing, the outer needle part 22 may also be guided in the nozzle body 3 in a plurality of guide faces, for instance offset by 120° from one another.

The inner needle part 23 of the multi-part, needle-like injection valve member 21, in the region above the inner pressure chamber 29, has a second diameter 39 (d₂), which exceeds the second seat diameter 34 (d₁); that is, d₂>d₁.

Because of the diameter ratio of d₁:d₂, where d₁<d₂, the inner needle part 23 of the multi-part, needle-like injection valve member 21 opens later than the outer needle part 22 of this injection valve member. The pressure step 28 on the inner needle part 23 which is located on its tip toward the combustion chamber and which is created by the difference in diameters d₂−d₁ has a considerably smaller hydraulically operative area, compared to the pressure steps 25, 26.

The mode of operation of the fuel injector 1 proposed according to the invention and shown in the drawing is as follows:

In the closed state, shown in the drawing, of the multi-part injection valve member 21, the actuator is supplied with current and is extended. Because current is being supplied to the actuator 6, which is preferably embodied as a piezoelectric actuator, its piezoelectric crystals, which are located one above the other in the form of a stack, lengthen and accordingly act on the booster piston 10. The second end face 12 of the booster piston moves into the first booster chamber 13. By means of the second end face 12 of the booster piston 10, the booster piston extension 14 is also retracted into the second booster chamber 17 of the hydraulic booster assembly 9. The first booster chamber 13 and the second booster chamber 17 are filled by way of the reference leakages between the outer needle part 22 and the nozzle body 3, the reference leakage between the inner needle part 23 and the injector body 2, and the reference leakage between the booster piston 10 and the fuel inlet 5.

Because of the imposition of pressure on the first booster chamber 13 and the second booster chamber 17, the first control chamber 19 acting on the inner needle part 23 and the second control chamber 20 acting on the outer needle part 22 are also subjected to pressure, so that the inner needle part 23 and the outer needle part 22 are put into their positions that close the respective seats 31 and 33.

Since at the same time, fuel at high pressure is present in the nozzle chamber 8 via the high-pressure supply line 7 and thus is also present in the annular gap 41, communicating with the nozzle chamber and surrounding the outer needle part 22, the fuel reaches only as far as the closed seat 31 of the outer needle part 22 and cannot be injected into the combustion chamber 43.

If the current supply to the actuator 6 is withdrawn, the lengthening of the piezoelectric crystals is reversed, and the booster piston 10 together with the booster piston extension 14 moves vertically upward. The stroke length of the booster piston 10 and booster piston extension 14 is in the range between 40 and 160 μm.

Accordingly, the first control chamber 19, which acts on the inner needle part 23, and the second control chamber 20, which acts on the end face 24, toward the control chamber, of the outer needle part 22 are likewise pressure-relieved. Because of the high fuel pressure in the nozzle chamber 8, the outer needle part 22 opens earlier, since an outer first pressure step 25 and an inner second pressure step 26 above the inner pressure chamber 29 are embodied on it. Accordingly, at the onset of the withdrawal of the current supply to the actuator 6, the end face 24, toward the control chamber, of the outer needle part 22 moves into the second control chamber 20, causing the seat 31 of the outer needle part 22 to be opened. As a result, the annular chamber 42 enters into communication with the annular gap 41, in which gap fuel at high pressure is present. The fuel at high pressure can be injected into the combustion chamber 43, during a first phase of the injection event, via the first injection openings 35.

During the first phase of the injection event, the inner needle part 23 of the multi-part, needle-like injection valve member 21 conversely remains in its closed position; that is, the seat 33 of the inner needle part 23 remains closed. In the further course of the injection event, the inner needle part 23 of the multi-part injection valve member 21 opens, since the pressure step 28 embodied on it is quite small.

In the further course of the injection event, fuel at high pressure flows via the pressure chamber inlets 30 into the inner pressure chamber 29 between the outer needle part 22 and the inner needle part 23. The fuel flowing into the inner pressure chamber 29 is present at the annular face 27 of the inner needle part 23 and urges the inner needle part further in the closing direction. During the vertical upward motion of the outer needle part 22, the annular gap 41 enters into communication with the annular chamber 42. As a consequence, a hydraulic force that is operative in the opening direction becomes operative on the pressure step 28 on the end toward the combustion chamber of the inner needle part 23 and moves this inner needle part in the opening direction. As a result, the second seat 33 of the inner needle part 23 is also opened, and fuel flows via the now-open second seat 33 to the second injection openings 36. With the inner needle part 23 and outer needle part 22 open at the same time, fuel flows out of the nozzle chamber 8 via the annular gap 41 via both injection openings 35, 36 into the combustion chamber 43. The diameter of the inner needle part 23, or in other words the first diameter 39, is in the range between 1.5 and 2.5 mm, while the diameter of the second control chamber 20 can be between 3.5 and 5.6 mm, depending on the embodiment of the fuel injector.

When current is supplied to the piezoelectric actuator 6, which is disposed in the fuel inlet 5 of the common rail, not shown in the drawing, the piezoelectric stack of the common rail expands, so that the booster piston 10 along with the booster piston extension 14 executes a closing motion acting in the direction of the combustion chamber 43. As a result, the fuel volumes contained in both the first booster chamber 13 and the second booster chamber 17 are compressed, and the control chambers 19 and 20 are subjected to pressure via the conduit 16 and the overflow line 18, respectively. Since the hydraulically operative areas that define the respective control chambers 19 and 20, or in other words the upper face end of the inner needle part 23 and the end face 24 of the outer needle part 22 toward the control chamber, exceed hydraulically operative areas of the pressure steps 25, 26 of the outer needle part 22 as well as the hydraulic area π(d₂²−d₁²)/4 that is operative in the opening direction, of the pressure step 28 on the end toward the combustion chamber of the inner needle part 23, both needle parts 22, 23 of the multi-part injection valve member 21 are returned to their closing position.

### LIST OF REFERENCE NUMERALS

1 Fuel injector
2 Injector body
3 Nozzle body
4 Butt joint
5 Fuel inlet
6 Piezoelectric actuator
7 High-pressure supply line
8 Nozzle chamber
9 Hydraulic booster assembly
10 Booster piston
11 First end face
12 Second end face
13 First booster chamber
14 Booster piston extension
15 Face end of booster piston extension
16 Conduit
17 Second booster chamber
18 Overflow line
19 First control chamber
20 Second control chamber
21 Multi-part injection valve member
22 Outer needle part
23 Inner needle part
24 End face of 22 toward control chamber
25 First pressure step of 22
26 Second pressure step of 22
27 Annular face of inner needle part 23
28 Pressure step of inner needle part 23
29 Inner pressure chamber
30 Pressure chamber inlet
31 Seat of outer needle part
32 First seat diameter
33 Seat of inner needle part
34 Second seat diameter
35 First injection openings
36 Second injection openings
37 Guide length of outer needle part 22
38 Guide length of inner needle part 23
39 First diameter of inner needle part 23
41 Annular gap
42 Annular chamber
43 Combustion chamber

1-10. (canceled)

11. In a fuel injector for a common rail injection system for injecting fuel into a combustion chamber of an internal combustion engine, the injector having an injector body, a nozzle body, an injection valve member embodied in multiple parts is received in the nozzle body, a piezoelectric actuator, a hydraulic booster assembly connected downstream of the piezoelectric actuator, and control chambers associated with the multi-part injection valve member for actuating the valve member, the improvement wherein the hydraulic booster assembly actuated by the piezoelectric actuator comprises first and second booster chambers which are each directly connected hydraulically with separate control chambers that actuate the needle parts of the injection valve member.

12. The fuel injector as recited in claim 11, wherein the first booster chamber communicates with a second control chamber for the outer needle part via a conduit, and the second booster chamber communicates with a first control chamber for the inner needle part.

13. The fuel injector as recited in claim 11, further comprising a pressure chamber embodied between the needle parts guided one inside the other, of the multi-part injection valve member, which pressure chamber can be filled from a nozzle chamber surrounding the multi-part injection valve member.

14. The fuel injector as recited in claim 11, further comprising a first and a second pressure step on the outer needle part and acting in the opening direction.

15. The fuel injector as recited in claim 13, further comprising a first and a second pressure step on the outer needle part and acting in the opening direction, the second pressure step being embodied in said pressure chamber.

16. The fuel injector as recited in claim 11, further comprising a pressure step embodied on the inner needle part, on the end thereof toward the combustion chamber, the hydraulic area of said pressure step on the inner needle part being operative in the opening direction of the inner needle part being less than the hydraulically operative areas of the first and second pressure steps of the outer needle part.

17. The fuel injector as recited in claim 11, wherein the hydraulically operative areas, in the opening direction, of the pressure steps of the outer needle part exceed the hydraulically operative area on the end toward the combustion chamber of the inner needle part.

18. The fuel injector as recited in claim 11, further comprising a first seat formed on the outer needle part and a second seat formed on the inner needle part, which seats cooperate with a wall of the nozzle body.

19. The fuel injector as recited in claim 11, wherein the piezoelectric actuator is integrated with the fuel inlet.

20. The fuel injector as recited in claim 11, further comprising first injection openings that can be opened or closed by the first seat and second injection openings that can be opened or closed by the second seat, said first and second injection openings being embodied on the nozzle body and opening in the direction of the combustion chamber.
